(19) United States
(12) Patent Application Publication
(10) Pub. No.: US 2014/0200054 A1
(43) Pub. Date: Jul. 17, 2014

(54) SENSING CASE FOR A MOBILE COMMUNICATION DEVICE

(71) Applicant: Jacob Fraden, San Diego, CA (US)

(72) Inventor: Jacob Fraden, San Diego, CA (US)

(73) Assignee: Fraden Corp., San Diego, CA (US)

(21) Appl. No.: 13/740,261

(22) Filed: Jan. 14, 2013

(51) Int. Cl. H04M 1/02

(52) U.S. Cl. CPC H04M 1/0202
USPC 455/575.8

(57) ABSTRACT

A protective case for enveloping a smartphone incorporates at least one sensor for detecting stimuli arriving from outside of the smartphone. The case and the phone form an integral unit that possess extra features than the phone alone wouldn't have. The sensor is supplemented by a signal conditioning and interface electronic circuit for communicating the sensed information to the smartphone inner processor. The communication is via a wired connection to the smartphone's connector or wireless via a radio waves or optical link. For expanding versatility of the smartphone, the sensors may be adapted for detecting non-contact temperature, light, ultrasonic, smell, material composition, human vital signs, and other signals.

This application claims the priority of a provisional U.S. patent application Ser. No. 61/737,739 filed on 15 Dec., 2012. The disclosure of the prior related application is hereby fully incorporated by reference herein.

### FIELD OF INVENTION

This invention relates to mobile communication devices, more specifically to accessories for handheld smartphones.

### DESCRIPTION OF PRIOR ART

Smart telephones became more and more versatile. Nowadays in their versatility, smart telephones resemble a Swiss Army Knife—a multi-function and multi-purpose item. Most wireless communication devices (cellular or mobile telephones, e.g.) incorporate additional non-communication features, such as imaging (photo and video), personal planners, games, navigation, etc. There are numerous inventions that attempt to include more features for measurement and/or monitoring external signals such as temperature and air pressure. An example is the electromagnetic radiation sensors as taught by the U.S. Pat. No. 8,275,413 issued to Fraden et al. and incorporated herein as reference. Especially of interest for practical applications are medical uses of the smartphones for patient monitoring, self-diagnostic and treatment.

For a chemical analysis and material composition a mass-spectrometry can be employed. A recent advancement in the MEMS technology allowed a construction a miniature sensor responsive to a single molecule as described in A. K. Naik et al. “Towards single-molecule nanomechanical mass spectrometry”. Nat. Nanotechnol. 4, 445-450 (2009). This chip can be incorporated in a mobile communication device or a carrying case.

Certain medical monitoring detectors can be imbedded directly into a smartphone and become an integral part of such. Yet, many more shouldn't be integrated into mobile communication devices (smart phones, e.g.) for various reasons. The key reason why all smartphones should not comprise a multitude imbedded sensors is a pure practicality. At least in a foreseeable future, many sensors would take a valuable space and increase cost—often this makes not much sense for a generic smartphone that is intended for a general population. Being “smart’ is good and beneficial, but being “too smart” is not always useful. For example, an air pressure or noncontact infrared temperature measurements may be very useful features during activities of certain phone owners (in a work place, hospital, travel, e.g.), yet they would not be needed at all for many other users that are not engaged in such activities. Incorporating monitors and sensors into smartphones while technically feasible, would increase cost, cause larger overall dimensions and reduce reliability. Further, numerous smartphone models being already in service, can't be retrofitted for adding the extra sensing features. One approach to this issue would be a use of an external attachment to a conventional telephone. However, such attachments may not be convenient for carrying around (and most consumers would never do that), are relatively bulky and require extra efforts for attaching and maintenance. Another and more practical approach is to imbed additional sensors and detectors into a conventional everyday accessory that is routinely used with a smartphone. Such a commonly used accessory is a protective jacket or case that envelops the exterior surface of a phone and absorbs impact forces if dropped on a floor. Most of such covers are designed just for a mechanical protection of the phone. However, the phone covers that in addition to their protective properties incorporate extra electronic circuitry are known in art and exemplified herein by the following. The U.S. Pat. No. 5,517,683 issued to Collett teaches an extension system that implements the additional electronic functions in a case attachable to an external surface of the cellular phone to form a physically integral unit with a connector to couple the extension electronics to the cellular phone electronics. U.S. Pat. No. 8,086,285 issued to McNamara et al. teaches a sound enhancing feature in a protective case. A phone case with electrical lights is taught by the U.S. Publication No. 20120302294 issued to Hammond et al. The U.S. Publication No. 20120285847 issued to Ollson teaches use of an electronic devices inside a protective case. U.S. Publication No. 20120088558 issued to Song et al. teaches an extra battery incorporated inside a protective case. A US company AliveCor (www.alivecor.com) developed the ECG screening monitor incorporated into a protective smartphone jacket. All foregoing patents, publications and the company are incorporated herewith as references. These devices and other inventions on record and known commercial products fail to address sensing a variety of external signals by a smartphone protective case.

Generally, there are two types of sensors that can be either imbedded into a smartphone or protective jacket. The sensors of the first type are responsive to external electrical signals, like voltage or charge, as exemplified by the above referenced the ECG screening monitor from AliveCor. The second type sensors are responsive to non-electrical external stimuli, for instance: pressure, chemical composition, temperature, light, as exemplified by the above referenced U.S. Pat. No. 8,275,413. The latter sensor type is characterized by a complex sensor design comprising at least one transducer of non-electrical energy to electrical signal, for example, a thermopile that converts the absorbed infrared light to heat, then coverts heat to electrical signal.

Thus, it is an object of the present invention to provide a protective cover for a smartphone that incorporates additional sensors and/or actuators.

It is another object of the present invention to increase versatility of a smartphone by adding sensors for electromagnetic radiation, chemical composition, ECG, pressure and other external factors of either electrical or non-electrical in nature.

And another goal of the invention is to develop a smartphone protective cover that can sense ECG signals with no physical contact with the patient body.

Further and additional objects and goals are apparent from the following discussion of the present invention and the preferred embodiments.

### SUMMARY OF THE INVENTION

A protective case for holding a smartphone incorporates at least one sensor for detecting signals caused by the stimuli external to the smartphone. The stimuli may be electrical or non-electrical. The case and the phone form an integral unit that possess the sensing features that the phone alone doesn't have. The sensor is supplemented by a signal conditioning and interface electronic circuit for communicating the sensed information to the inner processor of the smartphone. The communication may be via a wired connection to the smartphone connector or wirelessly via a radio wave or optical link. For expanding versatility of a smartphone, specific sensors imbedded into a protective sensing case may be adapted for detecting non-contact temperature, light, ECG, smell, chemical composition, ultrasonic and other external stimuli.

### BRIEF DESCRIPTION OF DRAWINGS

FIG. 1 illustrates isometric views of the back and front sides of a sensing case;

FIG. 2 is an illustration of a coupling of an internal connector to a sensing module;

FIG. 3 presents a diagrammatical view of mutual dispositions of the components;

FIG. 4 shows a top positioning of a sensing module;

FIG. 5 is a block-diagram of a module for sensing thermal radiation;

FIG. 6 is a block diagram of a sensing case for sensing thermal radiation and ECG;

FIG. 7 is a cross-sectional view of a capacitive dry ECG electrode;

FIG. 8 illustrates a ground electrode;

FIG. 9 illustrates an isometric view of a smartphone case with a removable top;

FIG. 10 is an isometric view of a case with a folding flap, containing a sensor;

FIG. 11 is a case with a feedback component;

FIG. 12 illustrates incorporation of a optical sensor into a phone case;

FIG. 13 shows a sensor protected by a lid.

Parts List for FIGS. 1-13

| | |
|---|---|
| 1 | back side |
| 2 | front side |
| 3 | camera opening |
| 4 | back wall exterior |
| 5 | back wall interior |
| 6 | connector |
| 7 | IR sensor lens |
| 8 | side extension |
| 9 | module |
| 10 | wiring harness |
| 11 | upper part |
| 12 | receptacle |
| 13 | slots |
| 14 | flat battery |
| 15 | smartphone |
| 16 | phone connector |
| 17 | link |
| 18 | ECG converter |
| 19 | openings |
| 20 | top extension |
| 21 | sensing jacket (case) |
| 22 | thermopile detector |
| 23 | signal conditioner |
| 24 | encoder |
| 25 | back wall |
| 26 | first ECG electrode |
| 27 | second ECG electrode |
| 28 | amplifier |
| 29 | signal conditioner |
| 30 | signal converter |
| 31 | electrode plate |
| 32 | isolator |
| 33 | follower |
| 34 | driven shield |
| 35 | electrode housing |
| 36 | follower output |
| 37 | bottom part |
| 38 | upper part |
| 39 | coupler one |
| 40 | coupler two |
| 41 | joint |
| 42 | back case |
| 43 | flap |
| 44 | flap thickness |
| 45 | pivot |
| 46 | mating portion |
| 47 | ground electrode |
| 48 | ground amplifier |
| 49 | output means |
| 50 | sensor |
| 51 | lid |
| 52 | axis |
| 53 | directions |
| 54 | wireless module |
| 55 | 1^{st} LED |
| 56 | 2^{nd} LED |
| 57 | photo detector |
| 58 | filter |

### DESCRIPTION OF PREFERRED EMBODIMENTS

In the following description, the words “smartphone”, “cell phone”, “phone” and “mobile communications device” are used interchangeably and generally have the same meaning. Likewise, words “case”, “cover” and “jacket” refer to the same item.

FIG. 1 illustrates the back, 1, and front, 2, sides of a protective case, 21, for holding a mobile communication device (a smartphone, e.g.). The case is designed for a snag fit over the exterior of a phone and not to interfere with its normal functions. Toward this goal, the case, 21, has one or more slots and openings, 13 and 19, for the phone controls, switches, microphone/speaker, etc. To protect the phone against damage, if dropped, the case is fabricated of an impact resistant and stress absorbent material. Example are polyurethane, phenolics and polycarbonate. Such materials are well known in art and not described herein. A front side of the case, 21, is open for providing an access to the phone display and controls, while the rear side preferably (but not necessarily) is protected by a wall having the back side, 4, and front side, 5. The connector, 6, may be incorporated inside the case, 21, for coupling to the inner electronic components and battery of the smartphone. On the upper side of the case, there is a side extension, 8, for housing certain components that will be described below. A shape and location of the side extension, 8, is arbitrary and depends on the ergonomic, esthetic and engineering requirements to the device.

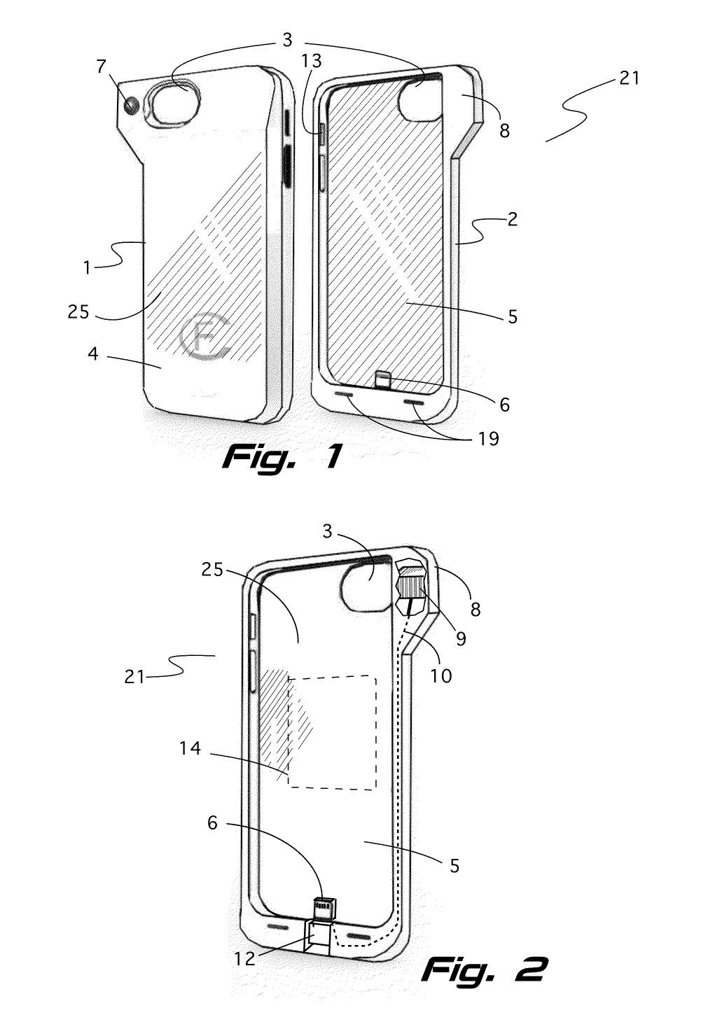

FIG. 2 shows the case, 21, that inside the side extension, 8, incorporates a module, 9, that may comprise one or more sensors of the external stimuli and supporting electronic circuits to perform additional functions for the phone. Examples of such components are: a thermopile detector for sensing thermal (infrared) radiation, air pressure sensor, UV light detector, signal converter, electromagnetic field detector, blood pulse oximeter, blood glucose meter, detector of a chemical composition, and many others. A spectrum of the electromagnetic field may range from UV to long waves to static electrical and magnetic fields. The module, 9, communicates with the smartphone (not shown in FIG. 2) through the connector, 6, that is attached to the module via a wiring harness, 10, such as a flexible circuit board, e.g. The connector, 6, may be directly attached to a receptacle, 12, that allows electrical connection of the smartphone to a peripheral equipment, for example, a battery charger or computer. Optionally, an additional battery, 14, may be incorporated inside the case, 21, for example, inside the back wall, 25.

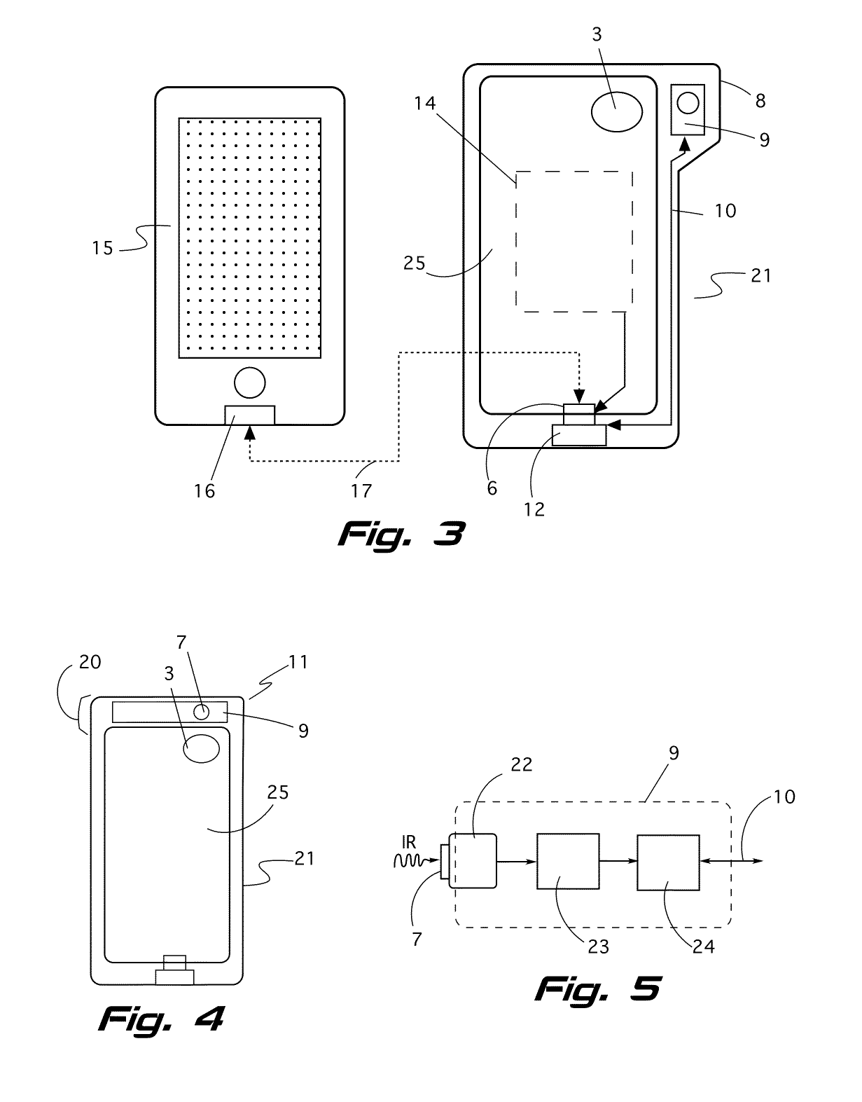

Before operation, smartphone, 15, in positioned inside the case, 21, with the phone inner connector, 16, being coupled to the case connector, 6, as illustrated in FIG. 3. For clarity only, the smartphone, 15, is shown outside of the case, 21 while the coupling is shown by a broken line, 17.

Alternatively, the smartphone, 15, may communicate with the module, 9, by a wireless means, for example by using a bidirectional radiofrequency or optical coupling. In that case, the module, 9, and smartphone, 15, must incorporate the appropriate coupling components that are well known in art and thus not described here. As a result, the connector, 6, and the wiring harness, 10, will not be required for a wireless communication between the case and the smartphone.

Optionally, module, 9, may be positioned in other areas of the case, 21, for example, inside the back wall, 25, or at the upper part, 11, as shown in FIG. 4. The latter placement will require a top extension, 20. Positioning of the module, 9, (or 10) depends on particular applications. For example, for a noncontact temperature measurement, lens, 7, of the IR detector should be positioned close to the digital camera lens protruding through the opening, 3.

If the jacket comprises a module that for operation requires certain disposable or reusable components, the jacket my be appended with a pocket for storing such components (not shown). An example is a set of disposable test strips for a glucometer. Likewise, certain actuators, either manual or electrical, also can be imbedded into the jacket. An example is a piercing blade (a blood lancet) for puncturing the patient skin to obtain a blood sample for a glucometer.

Most of the sensors imbedded into the case, 21, can't be directly coupled to the connector, 6, and thus require intermediate (interface) electronic circuits, such as signal conditioners, amplifiers, analog-to-digital converters, encoders, etc. As an illustration, FIG. 5 shows module, 9, incorporating the thermopile detector, 22, with the infrared lens, 7. The detector receives the incoming IR radiation and converts it into electric voltage that is fed to the signal conditioner, 23, that in turn is connected to the encoder, 24. Typically, the signal conditioner, 23, is comprised of an amplifier and filter, while the encoder, 24, is comprised of an analog-to-digital converter and a code adapter for matching a signal format in wiring harness, 10, with the signal format compatible with a particular model of a smartphone for which the case, 21, is intended. The sensor (a thermopile, e.g.) not necessarily should be part of the module, 9. For practical reasons, it may be external to the module, comprising a signal conditioning, encoding and communicating functions.

In this example of FIG. 5, a non-electrical stimulus (IR radiation) is converted by a thermopile detector, 22, first to heat and subsequently heat is converted to a small electrical voltage that is substantially proportional to the intensity of IR radiation received by the detector, 22. In other embodiments, a stimulus may be of an electrical nature, for example, electro-cardiographic (ECG) voltage naturally appearing over the patient's chest.

To illustrate operation of a sensor responsive to the ECG electrical stimuli, FIG. 6 shows the case, 21, that on the back wall exterior, 4, incorporates three non-contact ECG electrodes, 26, 27 and 47. The electrodes may be simple metal plates or they can be designed in a more complex form as shown below. For clarity, module, 9, and the electrodes are shown as removed from the case, 21, although in reality they are incorporated into the case. Note that more than one type of sensors may be incorporated into the same case, 21. This is illustrated by a thermopile detector, 22, (for thermal radiation) being part of the module, 9, with the IR lens, 7, protruding through the case, 21. The thermopile detector is in addition to the ECG electrodes and electronics.

Electrical signals from the ECG electrodes are amplified by the amplifier, 28, processed by the signal conditioner, 29 and converted to a digital format by the signal converter, 30. The same converter may be used to convert signals from the thermopile detector, 22. The digital signals pass to the connector, 6, and subsequently appear at receptacle, 12, for connecting to the external peripheral devices, if needed for calibration, e.g.

During operation, the non-contact active electrodes 26 and 27 and the ground electrode, 47, are pressed against the patient chest. Here term “non-contact” means that the conductive portions of the electrodes make no direct electrically conductive contact with the patient skin. Fundamentals of such an electrode system can be found in: Yu M. Chi et al. “Wireless Non-contact Cardiac and Neural Monitoring.” Wireless Health 2010, Oct. 5-7, 2010, San Diego, USA.

A more detailed schematic of an active non-contact capacitive electrode (26 or 27) is illustrated in FIG. 7. Word “active” here means having an imbedded electronic circuit. The electrode is comprised of an electrode plate, 31, that is made of a conductive material (metal or conductive polymer, e.g.), isolator, 32, voltage follower, 33, driven shield, 34, and the electrode housing, 35. Note that isolator, 32, should be thin (on the range of 1-10 mkm) and composed of an electrically non-conductive material having as high dielectric constant as practical, preferably more than 20. A high dielectric constant increases a capacitance between the patient skin (not shown) and the electrode plate, 31, thus improving quality of the recorded ECG signals at the lower part of the frequency spectrum. Examples of suitable materials for the isolator, 32, are certain ceramics, such as titanium dioxide (rutile) deposited on the electrode plate, 31. Thus, the electrode plate, 31, and isolator, 32, forms a unitary two-layer structure. Input of the voltage follower, 33, is connected to the electrode plate, 31, while the follower's output, 36, is connected to the electrically conductive driven shield, 34, and preferably to the electrode housing, 35, which also should be made of the electrically conductive material. The voltage follower, 33, has a very high input impedance on the order of several Gigohm and a very low output impedance in the ohm range. This assures a to sufficiently low cut-off frequency of the electrode and lower interferences. Note that driven shield, 34, is well isolated from the electrode plate, 31, but both are at substantially the same voltage (potential), thanks to a unity gain of the voltage follower, 33. “Substantial” here means be within 1% from one another. As a result, any stray capacitance between the driven shield and electrode plate becomes immaterial and makes no effect on the recorded signal.

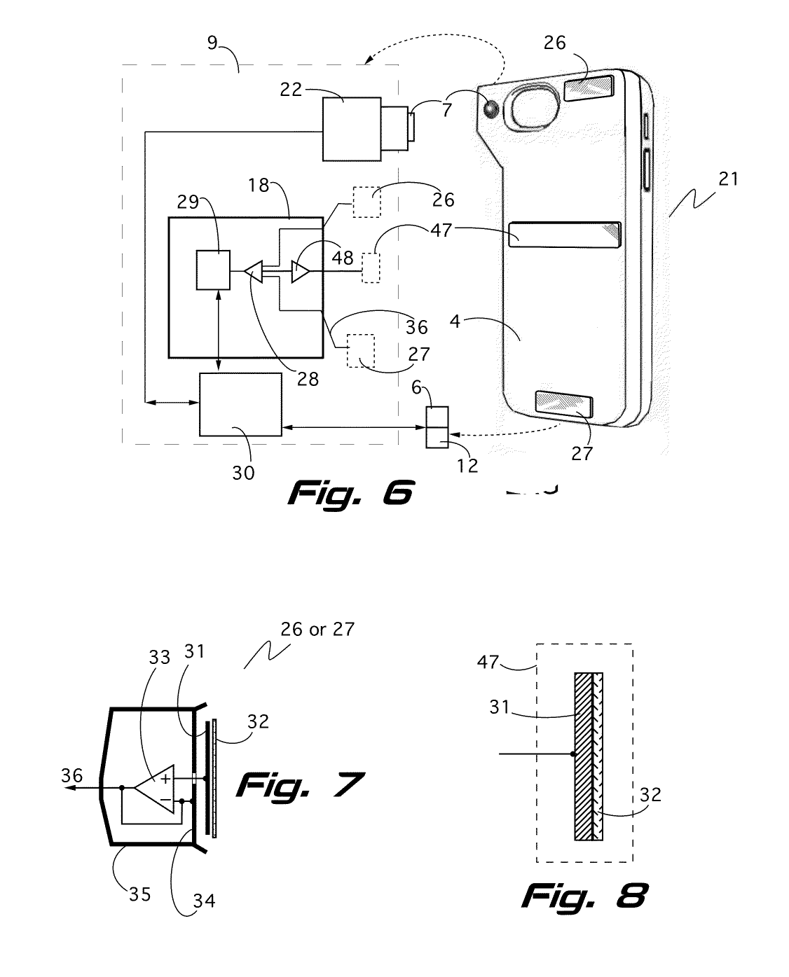

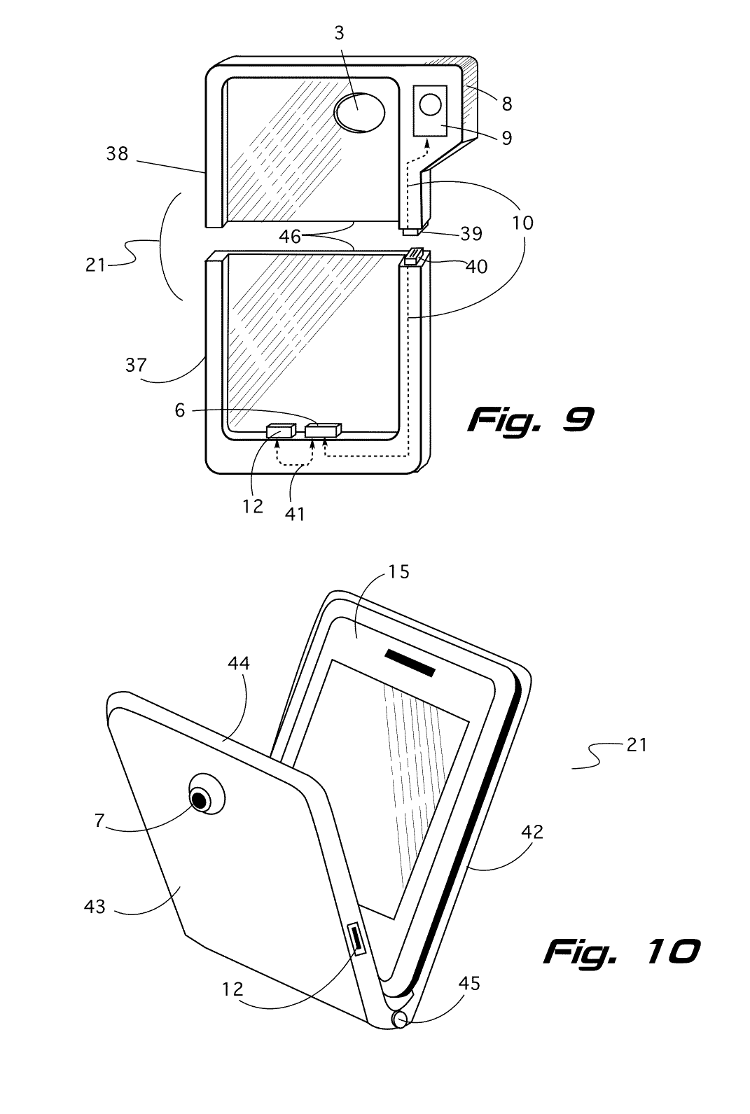

A capacitance between the electrode plate, 31, and the patient body provides a capacitive coupling for the ECG varying voltage. A voltage difference between the electrodes, 26 and 27, is amplified and in a digital format is fed to the smartphone inner electronics for processing. Note that the ground electrode, 47, is driven by a ground amplifier, 48. The ground electrode construction is shown in FIG. 8. Like an active electrode of FIG. 7, it also contains a conductive electrode plate, 21, and insulator, 32.

Note that thanks to very high input impedance of the voltage follower, 33, it may take a long time for an ECG signal to settle down for a normal recording after the case, 21, being placed onto the patient chest. This transition time can be significantly reduced by a momentary shorting together the electrode plates, 21, of both active electrodes, 26 and 27, to the electrode plate of the ground electrode, 47. This can be accomplished by a set of additional solid-state switches that are not shown in the drawings because details of the capacitive electrode design go beyond the scope of this disclosure.

Even though the mobile communication device (smartphone, e.g.) usually has a means for communication with the user, it may be beneficial to supplement the sensing case, 21, with an additional output means, 49 (FIG. 11), comprising one or more of the following: LCD, LED, speaker, vibrator. One example of the functionality of such an output means is providing a feedback to the user in case when communication with the smartphone can't be established.

Case, 21, can be designed in many modifications without departing from the key principles and spirit disclosed herein. As an illustration, FIGS. 9 and 10 illustrate two other embodiments of the invention. The embodiment of FIG. 9 shows a two-part case, 21, comprising the bottom part, 37 and the upper part, 38, where one part is fully detachable from another. During operation, both parts are slid over the smartphone housing and joined together. A sensor (or several sensors) can be positioned either in one part or both parts. If necessary, to assure continuity of the wiring harness, 10, at a mating portion, 46, of the case, 12, a coupler one, 39, is mated with a coupler two, 40. The couplers are the interconnecting devices. Note that the receptacle, 12, may be separated from connector, 6, and linked to it by an electrical joint, 41. The embodiment of FIG. 10 also shows a two-part case, 21, where both parts are joined together and can mutually rotate around pivot, 45. The back case, 42, envelops a portion of the body of a smartphone, 15, while flap, 43, may carry one or more sensors as illustrated by an optical sensor having the IR lens, 7. The receptacle, 12, may be located on the either part of the case, like on the flap, 43, as shown in FIG. 10. The flap thickness, 44, should be sufficient for housing all needed sensors and supporting electronic components.

FIG. 12 illustrates another embodiment of this invention comprising an optical sensor, 50. Note that the optical sensor can have a multitude configurations and applications and may operate in various portions of the optical spectral range—from UV to far infrared. As an example, FIG. 12 shows an optical sensor, 50, adapted for measuring percentage of a human hemoglobin oxygenation by a method of a pulse oxymetry. It incorporates a near IR light emitting diode−1^{st} LED, 55, a red light−2^{nd} LED, 56, and a photo detector, 57. These components are protected by an optical filter, 58, that is transparent in the near IR and red portions of the light spectrum. For measuring a hemoglobin oxygenation, the filter, 58, is pressed against a portion of the patient body, a finger tip, e.g. The method of pulse oxymetry is well known in art and thus not further described herein. Note that in this illustration, the case, 21, has no wired connection to a mobile communication device, but is connected to it via a wireless module, 54 (a “Bluetooth”, e.g.). Since there is no wired connection to a mobile communication device, electric power to the components incorporated into the case, 21, may be provided by a flat battery, 14, imbedded into the back wall, 25.

An optical sensor as described herein can be adapted for monitoring a heart rate of a human or animal subject by detecting a variable (modulated) light by the photo detector, 57. Alternatively, a heart rate me be computed from an R-wave of the ECG signal as detected by the embodiment shown in FIG. 6.

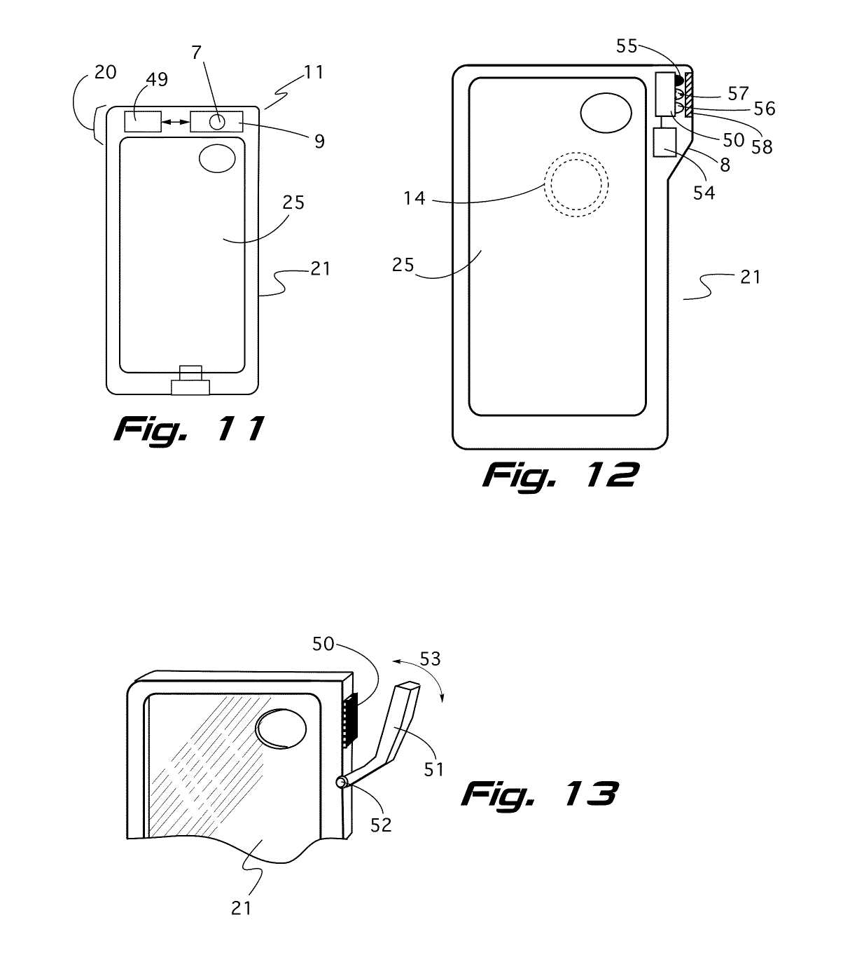

Some sensors after being incorporated into case, 21, may be quite delicate, thus requiring an additional protection from environment. This can be accomplished by appending case, 21, with a protective lid, 51, shown in FIG. 13. The lid, 52, can swing in directions, 53, around axis, 52 to an open and closed positions. If needed, the lid, 52, may incorporate certain additional components, like a photo detector, e.g. (not shown in FIG. 13).

While the present invention has been illustrated by description of various preferred embodiments and while these embodiments have been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known. However, the invention itself should only be defined by the appended claims.

1. A protective case for a mobile communication device, such device comprising a housing, a digital imaging camera having a lens, and an internal circuit, wherein the case is fabricated of an impact-resistant material and wraps around of at least an external portion of the housing and comprises:
an extension having an internal cavity that houses at least one sensor being disposed in a close proximity with the lens and adapted for responding to a stimulus received from the space being outside of the case and the mobile communication device, such space is visible by the lens.

2. The case for a mobile communication device of claim 1 further comprising an electronic module for a signal conditioning and processing, such module being connected to the sensor.

3. The case for a mobile communication device of claim 2 further comprising a connector for a wired coupling the electronic module to said internal circuit.

4. The case for a mobile communication device of claim 2 wherein the case further comprises a communication circuit that is adapted for a wireless coupling the electronic module to the internal circuit.

5. (canceled)

6. (canceled)

7. The case for a mobile communication device of claim 1 further comprising an output means, such output means being selected from a set comprising a light source, liquid crystal display, vibrating device, and audio producing device.

8. The case for a mobile communication device of claim 1 wherein the sensor is selected from a group comprising optical detector, electrical electrode, magnetic sensor, temperature sensor, pressure sensor, chemical sensor, tactile sensor, and electromagnetic field sensor.

9. A method of detecting a stimulus having a value and carrying information by a protective case of a mobile communication device for the use by an operator, comprising the steps of:
providing a mobile communication device comprising a housing, a digital imaging camera having a lens, and inner circuit;
providing a removable protective case for surrounding at least a portion of the housing and having an opening for exposing the lens to space being outside of the case;
providing an extension attached to the case and including an internal cavity, being disposed in close proximity to the opening;
incorporating into the internal cavity at least one sensor adapted for responding to the stimulus and generating a signal corresponding to the stimulus value, such sensor is selected from the group comprising a sensor for electromagnetic radiation in any spectral range, force sensor, pressure sensor, motion sensor, material composition sensor, electric field sensor, ionizing radiation sensor, magnetic field sensor, and electrical characteristic sensor;
communicating the signal to the inner circuit, and
processing said signal by the inner circuit to communicate to the operator the information related to the value of the stimulus.

10. (canceled)

11. The method of detecting stimulus of claim 9 further providing a module for receiving and conditioning the signal and providing a communication to the inner circuit.

12. (canceled)

13. (canceled)

14. (canceled)

15. (canceled)

16. (canceled)

17. (canceled)

18. (canceled)

19. (canceled)

20. (canceled)

21. A removable protective case for an electronic device, such device having an electronic circuit and a housing, wherein the case is being fabricated of a stress-resistant material and mechanically coupled to the housing at more than one side, the case comprising:
an extension having an internal cavity, wherein the internal cavity houses at least one sensor generating a signal when used together with a test component being adapted for modifying a property of an external object.

22. A removable protective case of claim 21 wherein said signal is being communicated to the electronic circuit of the electronic device.

23. A removable protective case of claim 21 wherein said sensor is responsive to at least one stimulus from the group of temperature, pressure, ionizing radiation, chemical composition, electromagnetic radiation, light, voltage, electrical and magnetic fields.

24. The case for a mobile communication device of claim 1, wherein said extension comprises an opening for communicating the signal to the sensor.

25. The method of detecting a stimulus of claim 9, further comprising forming an opening in said extension for communicating the stimulus to the sensor.

26. A removable protective case of claim 21, further comprising a pocket for housing the test component.

27. A removable protective case of claim 21, further comprising an actuator for enabling interaction between the test component and the object, such interaction for generating a stimulus received by the sensor.
